(19) United States
(12) Patent Application Publication
(10) Pub. No.: US 2025/0162567 A1
(43) Pub. Date: May 22, 2025

(54) VEHICLE

(71) Applicant: TOYOTA JIDOSHA KABUSHIKI KAISHA, Toyota-shi (JP)

(72) Inventors: Tomokazu AKUTSU, Toyota-shi (JP); Masanao IDOGAWA, Toyota-shi (JP)

(73) Assignee: TOYOTA JIDOSHA KABUSHIKI KAISHA, Toyota-shi (JP)

(21) Appl. No.: 18/890,867

(22) Filed: Sep. 20, 2024

(30) Foreign Application Priority Data
Nov. 20, 2023 (JP) 2023-196837

(51) Int. Cl. B60W 10/06; F02D 37/02; F02D 41/02

(52) U.S. Cl. CPC B60W 10/06; F02D 37/02; F02D 41/029; F02D 2200/1002

(57) ABSTRACT

A vehicle includes an engine as a traveling power source, a filter that collects exhaust particulates from the engine, a sensor configured to detect a correlation value correlated with a friction torque of the engine, and a control unit configured to execute temperature rise control for raising a temperature of the filter by controlling the engine to raise a temperature of exhaust gas of the engine.

### CROSS-REFERENCE TO RELATED APPLICATION

This application is based upon and claims the benefit of priority of the prior Japanese Patent Application No. 2023-196837, filed on Nov. 20, 2023, the entire contents of which are incorporated herein by reference.

### TECHNICAL FIELD

The present disclosure relates to a vehicle.

### BACKGROUND

In order to prevent clogging of the filter, temperature rise control is executed to increase the temperature of the filter and burn exhaust particulates trapped in the filter (see, for example, Japanese Unexamined Patent Application Publication No. 2022-036181).

The temperature of lubricating oil of the engine gradually increases from the cold start to the completion of the warm-up, and the friction torque of the engine gradually decreases accordingly. As a result, for example, when the vehicle speed is constant, the accelerator opening operated by the driver also gradually decreases with the decrease in the friction torque. As a result, the temperature of the exhaust gas of the engine gradually decreases. If the temperature rise control is executed without considering such a decrease in the friction torque, the temperature of the filter might excessively rise or the temperature of the filter might not sufficiently rise, and thus clogging of the filter might not be prevented.

### SUMMARY

It is therefore an object of the present disclosure to provide a vehicle capable of preventing excessive temperature rise and clogging of a filter.

The above object is achieved by a vehicle including: an engine as a traveling power source; a filter that collects exhaust particulates from the engine; a sensor configured to detect a correlation value correlated with a friction torque of the engine; and a control unit configured to execute temperature rise control for raising a temperature of the filter by controlling the engine to raise a temperature of exhaust gas of the engine, wherein the control unit is configured to increase a temperature rise rate of the exhaust gas in the temperature rise control as the friction torque indicated by the correlative value decreases.

The correlated value may be a temperature of a lubricating oil for lubricating the engine or a temperature of a coolant for cooling the engine.

The control unit may be configured to increase the temperature rise rate in the temperature rise control by controlling an ignition timing of the engine to a retard side.

The control unit may be configured to increase the temperature rise rate of the temperature rise control by at least one of a decrease in an EGR rate, an increase in a difference in an air-fuel ratio in dither control, and an increase in a required charging rate per unit time of a battery charged with electric power generated by power of the engine.

The vehicle may further include: a motor as a traveling power source; and a battery configured to transmit and receive electric power to and from the motor.

### BRIEF DESCRIPTION OF THE DRAWINGS

FIG. 1 is a schematic configuration view of a hybrid vehicle;

FIG. 2 is a schematic structural view of an engine;

FIG. 3A is a time chart illustrating a change in a temperature rise rate of exhaust gas due to a decrease in frictional torque from cold start to completion of warm-up; FIG. 3B is a time chart illustrating a change in a temperature rise rate of exhaust gas due to temperature rise control in a comparative example; and FIG. 3C is a time chart illustrating a change in the temperature of a GPF due to a decrease in frictional torque and temperature rise control in the comparative example;

FIG. 4A is a time chart illustrating a change in a temperature rise rate of exhaust gas due to the decrease in the frictional torque from the cold start to the completion of the warm-up, FIG. 4B is a time chart illustrating a change in the temperature rise rate of exhaust gas due to the temperature rise control in the present embodiment; and FIG. 4C is a time chart illustrating a change in a temperature of the GPF due to the decrease in the frictional torque and the temperature rise control in the present embodiment;

FIG. 5 is a flowchart illustrating an example of the temperature rise control executed by the ECU in the present embodiment; and

FIG. 6 is an exemplary view of a map that defines a target ignition timing according to the temperature of a lubricating oil in the temperature rise control.

### DETAILED DESCRIPTION

### [Schematic Configuration of Hybrid Vehicle]

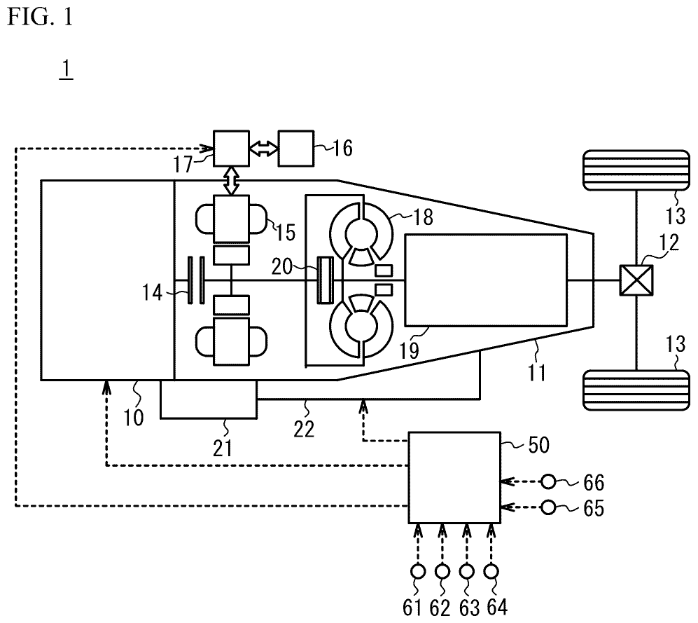

FIG. 1 is a schematic configuration view of a hybrid vehicle 1. The hybrid vehicle 1 is equipped with an engine 10 and a motor 15 as travelling power sources. The engine 10 is a gasoline engine having a plurality of cylinders, but may be a diesel engine. A transmission unit 11 is provided on a power transmission path from the engine 10 to drive wheels 13. The transmission unit 11 and the left and right drive wheels 13 are drivingly connected to each other via a differential 12.

The transmission unit 11 is provided with a K0 clutch 14 and the motor 15. The motor 15 is provided on a power transmission path from the engine 10 to the drive wheels 13.

The K0 clutch 14 is provided between the engine 10 and the motor 15 in the power transmission path. The K0 clutch 14 is engaged by receiving the oil pressure, and connects the engine 10 and the motor 15 for power transmission. The K0 clutch 14 is released in response to the stop of the oil pressure supply.

The motor 15 is connected to a battery 16 via an inverter 17. The battery 16 is a chargeable and dischargeable secondary battery such as a nickel-hydrogen cell or a lithium-ion battery. The motor 15 functions as a motor that generates a driving force of the vehicle in response to power supply from the battery 16. The motor 15 also functions as a generator that generates electric power for charging the battery 16 in response to power transmitted from the engine 10 and the drive wheels 13. The electric power transmitted between the motor 15 and the battery 16 is adjusted by the inverter 17.

The transmission unit 11 is provided with a torque converter 18 and an automatic transmission 19. The torque converter 18 is a fluid coupling having a torque amplifying function. The automatic transmission 19 is a stepped transmission that switches the gear ratio in multiple stages. The torque converter 18 is provided between the motor 15 and the drive wheels 13 on the power transmission path. The automatic transmission 19 is provided between the torque converter 18 and the drive wheels 13 on the power transmission path. The torque converter 18 is provided with a lock-up clutch (hereinafter referred to as an LU clutch) 20 that is engaged by receiving a supply of hydraulic pressure to directly couple the motor 15 and the automatic transmission 19.

The LU clutch 20 is engaged by receiving the hydraulic pressure, and connects the power transmission between the motor 15 and the drive wheels 13. The LU clutch 20 is released in response to the stop of the hydraulic pressure supply.

The transmission unit 11 is further provided with an oil pump 21 and a hydraulic control mechanism 22. The oil pressure generated by the oil pump 21 is supplied to the K0 clutch 14, the torque convertor 18, the automatic transmission 19, and the LU clutch 20 via the hydraulic control mechanism 22. The hydraulic control mechanism 22 is provided with hydraulic circuits for the K0 clutch 14, the torque convertor 18, the automatic transmission 19, and the LU clutch 20, and various hydraulic control valves for controlling the hydraulic pressures of these components.

The hybrid vehicle 1 is provided with an electronic control unit (ECU) 50 as a control unit of the hybrid vehicle 1. The ECU 50 includes a processing circuit that performs various processing related to the traveling control of the automobile. The ECU 50 is an example of the control unit of the hybrid vehicle 1, and executes temperature rise control described later in detail.

An ignition switch 61, a crank angle sensor 62, an air flow meter 63, an air-fuel ratio sensor 64, an oil temperature sensor 65, and a coolant temperature sensor 66 are connected to the ECU 50. The ignition switch 61 detects whether the ignition is turned on or off. The crank angle sensor 62 detects the rotational speed of the crankshaft of the engine 10. The air flow meter 63 detects the amount of intake air introduced into the engine 10. The air-fuel ratio sensor 64 detects the air-fuel ratio of the exhaust gas of the engine 10. The oil temperature sensor 65 detects the temperature of the lubricating oil of the engine 10. The coolant temperature sensor 66 detects the temperature of the cool coolant for the engine 10.

The ECU 50 controls the driving of the engine 10 and the motor 15. In particular, the ECU 50 controls the torque of the motor 15 by controlling the inverter 17 to adjust the amount of electric power exchanged between the motor 15 and the battery 16. The ECU 50 controls the K0 clutch 14, the LU clutch 20, and the automatic transmission 19 through the control of the hydraulic control mechanism 22.

The ECU 50 causes the hybrid vehicle 1 to travel in either the motor travel mode or the hybrid travel mode. In the motor drive mode, the ECU 50 disengages the K0 clutch 14 and rotates the drive wheels 13 by the power of the motor 15. In the hybrid drive mode, the ECU 50 engages the K0 clutch 14 to rotate the drive wheels 13 by the power of at least one of the engine 10 and the motor 15.

### [Schematic Configuration of Engine]

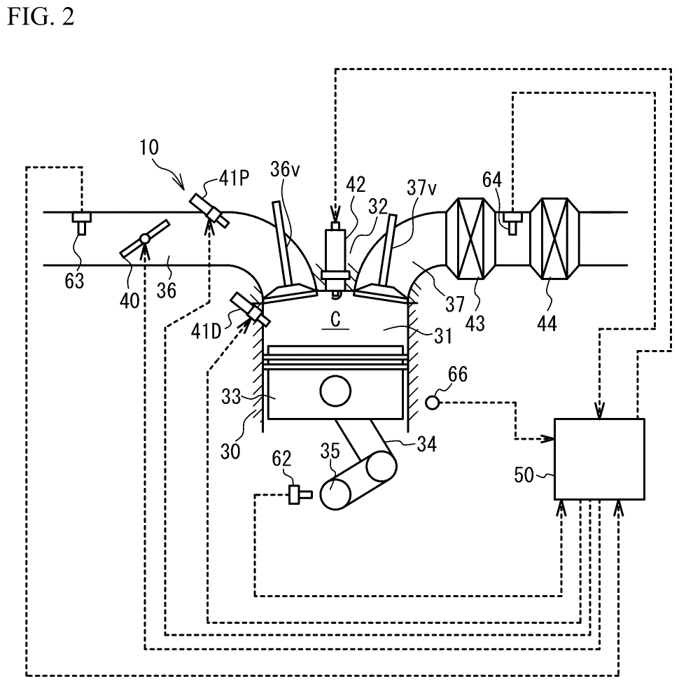

FIG. 2 is a schematic configuration view of the engine 10. The engine 10 includes a cylinder block 30, a cylinder head 32, a piston 33, a connecting rod 34, a crankshaft 35, an intake passage 36, an intake valve 36v, an exhaust passage 37, and an exhaust valve 37v.

The cylinder block 30 is provided with a cylindrical bore 31. The piston 33 is accommodated in the bore 31 so as to be capable of reciprocating. A combustion chamber C is defined by a wall surface of the bore 31, a lower surface of the cylinder head 32, and a top surface of the piston 33. The volume of the combustion chamber C increases and decreases by the reciprocating motion of the piston 33.

The connecting rod 34 is connected to the crankshaft 35 which is an output shaft of the engine 10. The connecting rod 34 and the crankshaft 35 convert the reciprocating motion of the piston 33 into the rotational motion of the crankshaft 35. The engine 10 is provided with the above-described crank angle sensor 62.

The intake passage 36 is connected to the combustion chamber C via the intake valve 36v. The exhaust passage 37 is connected to the combustion chamber C via the exhaust valve 37v. The intake passage 36 is provided with the above-mentioned air flow meter 63.

The cylinder block 30 is provided with in-cylinder injector 41D that directly injects fuel into the combustion chambers C. The intake passage 36 is provided with a port injector 41P that injects fuel toward the intake port. The cylinder head 32 is provided with an ignition plug 42 that ignites a mixture of intake air and fuel introduced into the combustion chamber C. Note that only one of the in-cylinder injector 41D and the port injector 41P may be provided.

A three way catalyst 43 and a GPF (Gasoline Particulate Filter) 44 are provided in the exhaust passage 37. The three way catalyst 43 contains a catalyst metal, has an oxygen storage capacity, and purifies NOx, HC, and CO. The GPF 44 is a porous-ceramic structure and collects exhaust particulates (hereinafter referred to as PM (Particulate Matter)) in the exhaust gas. The GPF 44 is an example of a filter. For example, when the engine 10 is a diesel engine, a diesel particulate filter (DPF) is provided instead of the GPF 44. The air-fuel ratio sensor 64 is provided between the three way catalyst 43 and the GPF 44. The air-fuel ratio sensor 64 detects the air-fuel ratio of the exhaust gas discharged from the three way catalyst 43.

The ECU 50 controls the opening degree of a throttle valve 40, the fuel injection amounts of the in-cylinder injector 41D and the port injector 41P, the ignition timing of the ignition plug 42, and the like based on the detection signals of the above-described sensors, thereby controlling the driving of the engine 10.

The ECU 50 executes temperature rise control for raising the temperature of the GPF 44 when a predetermined condition is satisfied in the hybrid traveling mode. The temperature rise control is performed to promote combustion of PM deposited in the GPF 44. The predetermined condition is that the amount of PM deposited in the GPF 44 is equal to or greater than a predetermined value. The method of estimating the amount of PM deposited may be, for example, estimation based on the drive history of the engine 10 from the completion of the previous temperature rise control, or on the differential pressure in front and back of the GPF 44, or the like, or may be estimation by another known method. The temperature rise control will be described below.

### [Temperature Rise Control]

In the present embodiment, the temperature rise control is executed by the ignition timing retard processing for controlling the ignition timing to the retard side from the basic ignition timing. The amount of heat of the exhaust gas is increased by the ignition timing retarding process, and the temperature of the GPF 44 is increased. Thus, the PM deposited on the GPF 44 is burned.

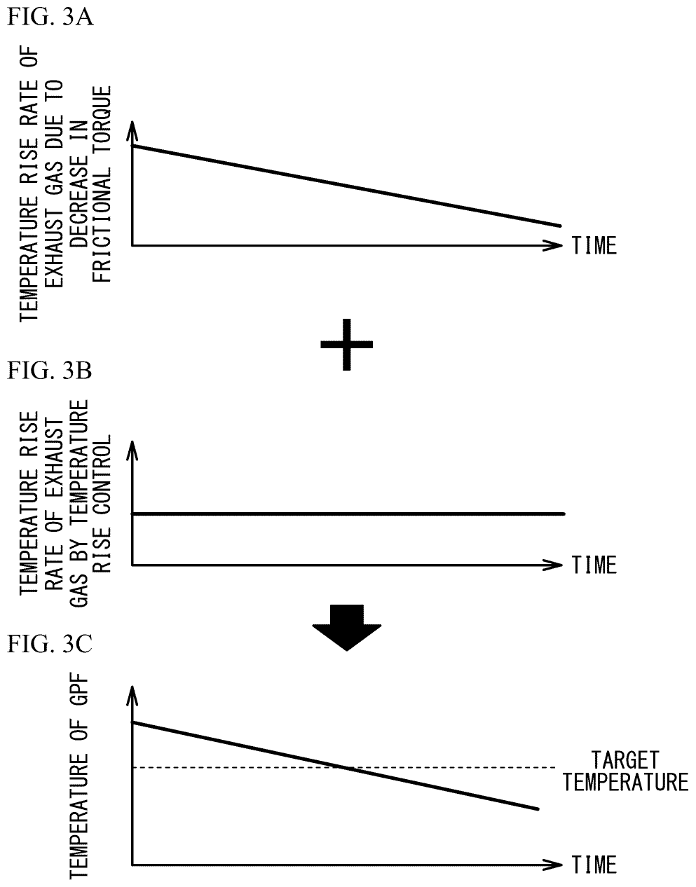

However, the following problem may occur from the cold start of the engine 10 to the completion of the warm-up. FIG. 3A is a time chart illustrating a change in the temperature rise rate of exhaust gas due to the decrease in the frictional torque from the cold start to the completion of the warm-up. FIG. 3B is a time chart illustrating a change in the temperature rise rate of exhaust gas by temperature rise control in the comparative example. FIG. 3C is a time chart illustrating a change in the temperature of the GPF 44 due to the temperature rise control in the comparative example. FIGS. 3A to 3C illustrate a case where the vehicle travels at a constant vehicle speed as an example. The temperature rise rate in FIG. 3A illustrates the temperature rise rate of exhaust gas due to friction torque, with respect to the temperature of the exhaust gas at the time of completion of warm-up in a case where temperature rise control is not executed. The temperature rise rate in FIG. 3B illustrates the temperature rise rate of exhaust gas due to the temperature rise control, with respect to the temperature of the exhaust gas at the time of completion of warm-up. The friction torque is a friction torque that acts as a resistance against the rotation of the engine 10.

From the cold start to the completion of the warm-up, the temperature of the lubricating oil of the engine 10 gradually increases, and the friction torque of the engine 10 gradually decreases. When the vehicle speed is maintained constant, the accelerator opening degree decreases as the friction torque decreases. As the accelerator opening decreases, the temperature of the exhaust gas also decreases. Therefore, from the cold start to the completion of the warm-up, the temperature rise rate of the exhaust gas gradually decreases due to the decrease in the frictional torque as illustrated in FIG. 3A. When the temperature rise control is executed under such a situation with the temperature rise rate of the exhaust gas being constant, the temperature of the GPF 44 illustrated in FIG. 3C decreases from a temperature higher than the target temperature to a temperature lower than the target temperature. Therefore, the GPF 44 is excessively heated, and then the temperature of the GPF 44 is insufficiently raised, which might make it impossible to prevent clogging.

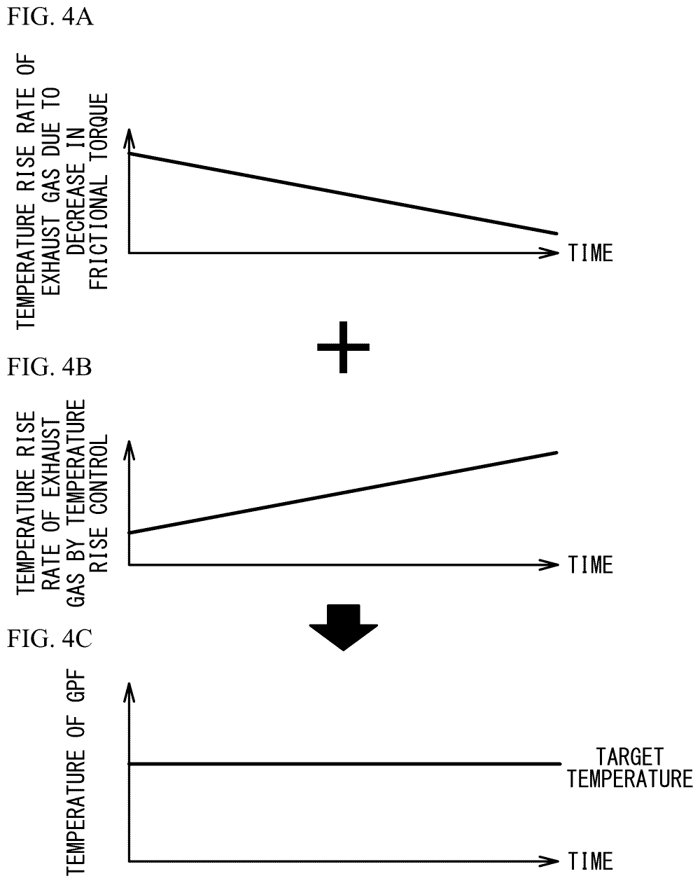

FIG. 4A is a time chart illustrating a change in the temperature rise rate of the exhaust gas due to the decrease in the frictional torque from the cold start to the completion of the warm-up. FIG. 4B is a time chart illustrating a change in the temperature rise rate of the exhaust gas by the temperature rise control in the present embodiment. FIG. 4C is a time chart illustrating a change in the temperature of the GPF 44 due to the temperature rise control in the present embodiment. Note that FIG. 4A is the same as FIG. 3A, and the FIGS. 4B and 4C correspond to the FIGS. 3B and 3C, respectively. In the temperature rise control executed by the ECU 50 in the present embodiment, the temperature rise rate of the exhaust gas by the temperature rise control gradually increases so as to cancel out a decrease in the temperature rise rate of the exhaust gas due to a decrease in the frictional torque. Thus, the temperature of the GPF 44 is maintained at the target temperature. The ECU 50 in the present embodiment executes the temperature rise control as follows.

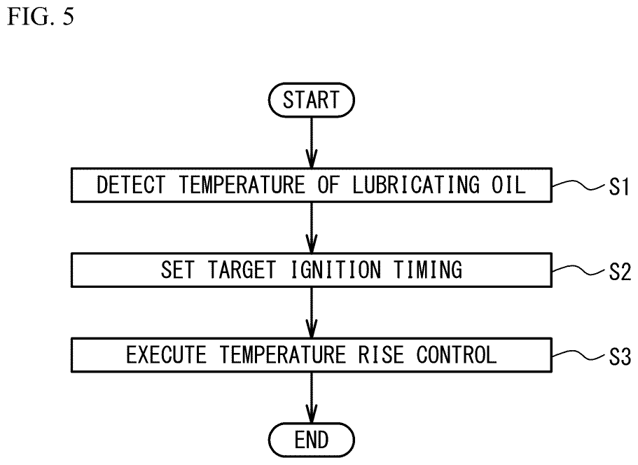

FIG. 5 is a flowchart illustrating an example of the temperature rise control executed by the ECU 50 in the present embodiment. This control is repeatedly executed while the ignition is on. The ECU 50 detects the temperature of the lubricating oil of the engine 10 based on the oil temperature sensor 65 (step S1). The temperature of the lubricating oil is an example of a correlation value correlated with the friction torque of the engine 10. This is because the viscosity of the lubricating oil decreases as the temperature of the lubricating oil increases, and the friction torque of the engine 10 decreases.

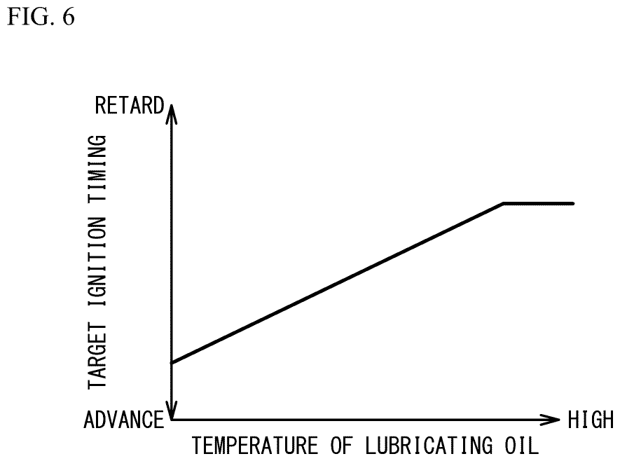

Next, the ECU 50 sets the target ignition timing based on the temperature of the lubricating oil (step S2). FIG. 6 is an exemplary view of a map that defines the target ignition timing according to the temperature of the lubricating oil in the temperature rise control. As illustrated in FIG. 6, the target ignition timing is set to the retard side as the temperature of the lubricating oil is higher. Thus, the temperature rise rate of the exhaust gas increases as the temperature of the lubricant increases and the friction torque of the engine 10 decreases. Note that FIG. 6 illustrates the target ignition timing in the case where the engine speed and the engine torque are constant. The target ignition timing is set to the advance side as the engine speed is higher and the engine torque is larger.

Next, the ECU 50 executes the temperature rise control by controlling the ignition timing to the calculated target ignition timing (step S3). Thus, as illustrated in FIG. 4C, it is possible to suppress an excessive temperature rise of the GPF 44 and clogging of the GPF 44.

In the above present embodiment, the control for adjusting the ignition timing has been described as an example of the temperature rise control. For example, when the engine has an exhaust gas recirculation (EGR) device, the temperature rise control may be achieved by adjusting an EGR rate. The EGR rate is a ratio of the amount of EGR gas to the amount of intake gas supplied to the engine 10. As the EGR rate decreases, the pumping loss increases and the temperature of the exhaust gas rises. Therefore, the temperature rise rate of the exhaust gas in the temperature rise control is increased by decreasing the EGR rate as the temperature of the lubricating oil increases.

Further, the temperature rise control may be achieved by adjusting the difference in the air-fuel ratio in dither control. The dither control is control for setting at least one of the plurality of cylinders of the engine 10 to a lean air-fuel ratio and setting the remaining cylinders to a rich air-fuel ratio. In this case, the larger the difference between the lean air-fuel ratio and the rich air-fuel ratio, the higher the temperature of the exhaust gas fed to the GPF 44. Therefore, by increasing the difference in the air-fuel ratio as the temperature of the lubricating oil increases, the temperature rise rate of the exhaust gas in the temperature rise control is increased.

The temperature rise control may be achieved by adjusting a required charging rate per unit time of the battery 16. The motor 15 generates electric power by receiving the power of the engine 10, and the generated electric power is charged in the battery 16. Therefore, the higher the required charging rate per unit time of the battery 16, the higher the temperature of the exhaust gas. Therefore, by increasing the required charging rate per unit time as the temperature of the lubricating oil increases, the temperature rise rate of the exhaust gas in the temperature rise control is increased.

The temperature rise control may be achieved by executing at least of two of the adjustment of the ignition timing, the adjustment of the EGR rate, the adjustment of the difference in the air-fuel ratio in the dither control, and the adjustment of the required charging rate of the battery 16 as described above.

In the above present embodiment, the temperature of the lubricating oil is used as the correlation value. However, for example, in a vehicle that is not provided with an oil temperature sensor, the temperature of the coolant detected by a coolant temperature sensor may be used as the correlation value. This is because the higher the temperature of the coolant, the higher the temperature of the engine 10, and the higher the temperature of the engine 10, the higher the temperature of the lubricating oil.

As described above, the hybrid vehicle 1 includes the motor 15 and the battery 16 in addition to the engine 10. For example, the battery 16 supplies electric power to the motor 15 as a traveling power source, and is charged with regenerative electric power of the motor 15. Therefore, the battery 16 is heavier than a battery mounted on an engine vehicle. As described above, the weight of the hybrid vehicle 1 is greater than that of the engine vehicle. Thus, the load on the engine 10 in the hybrid drive mode is higher than that on the engine of the engine vehicle. Therefore, the amount of PM discharged in the hybrid traveling mode might increase as compared with the engine vehicle. Therefore, the contents of the above present embodiment are suitable for the hybrid vehicle 1.

The contents of the above present embodiment may be applied to the control unit of an engine vehicle having only an engine as a traveling power source. The contents of the above present embodiment may be applied to a control unit of a hybrid vehicle in which an engine and a first motor are connected to a drive shaft coupled to drive wheels via a planetary gear, and a second motor is connected to the drive shaft.

Although some embodiments of the present disclosure have been described in detail, the present disclosure is not limited to the specific embodiments but may be varied or changed within the scope of the present disclosure as claimed.

What is claimed is:

1. A vehicle comprising:
an engine as a traveling power source;
a filter that collects exhaust particulates from the engine;
a sensor configured to detect a correlation value correlated with a friction torque of the engine; and
a control unit configured to execute temperature rise control for raising a temperature of the filter by controlling the engine to raise a temperature of exhaust gas of the engine,
wherein the control unit is configured to increase a temperature rise rate of the exhaust gas in the temperature rise control as the friction torque indicated by the correlative value decreases.

2. The vehicle according to claim 1, wherein the correlated value is a temperature of a lubricating oil for lubricating the engine or a temperature of a coolant for cooling the engine.

3. The vehicle according to claim 1, wherein the control unit is configured to increase the temperature rise rate in the temperature rise control by controlling an ignition timing of the engine to a retard side.

4. The vehicle according to claim 1, wherein the control unit is configured to increase the temperature rise rate of the temperature rise control by at least one of a decrease in an EGR rate, an increase in a difference in an air-fuel ratio in dither control, and an increase in a required charging rate per unit time of a battery charged with electric power generated by power of the engine.

5. The vehicle according to claim 1, further comprising:
a motor as a traveling power source; and
a battery configured to transmit and receive electric power to and from the motor.
